(19) United States
(12) Patent Application Publication
(10) Pub. No.: US 2024/0064078 A1
(43) Pub. Date: Feb. 22, 2024

(54) TRANSMISSION DEVICE, SYSTEM AS WELL AS METHOD FOR TRANSMITTING MONITORING INFORMATION

(71) Applicant: Rohde & Schwarz GmbH & Co. KG, Munich (DE)

(72) Inventor: Bjoern Schmid, Munich (DE)

(73) Assignee: Rohde & Schwarz GmbH & Co. KG, Munich (DE)

(21) Appl. No.: 18/450,065

(22) Filed: Aug. 15, 2023

Related U.S. Application Data
(63) Continuation of application No. 15/937,488, filed on Mar. 27, 2018, now abandoned.

(30) Foreign Application Priority Data
Mar. 28, 2017 (EP) 17163287.0

(51) Int. Cl. H04L 43/08; H04L 69/40; H04L 9/40; H04L 43/0823; H04L 41/0213; G06F 11/07

(52) U.S. Cl. CPC H04L 43/08; H04L 69/40; H04L 63/108; H04L 43/0847; H04L 41/0213; G06F 11/0709; G06F 11/0793; H04L 63/0272; H04L 63/0853; G06F 2201/805

(57) ABSTRACT

A transmission device for transmitting monitoring information is described, wherein the transmission device is configured to gather the monitoring information of a broadcasting and/or streaming unit that is configured to generate a transport stream for broadcasting and/or streaming. The transmission device is further configured to transmit the monitoring information gathered to a cloud unit via a secure connection. Further, a system and a method for transmitting monitoring information are described.

### CROSS-REFERENCE TO RELATED APPLICATION

This application is a continuation of U.S. application Ser. No. 15/937,488, filed on Mar. 27, 2018, the entire disclosure of which is incorporated herein in its entirety.

### FIELD OF THE DISCLOSURE

Embodiments of the present disclosure relate to a transmission device for transmitting monitoring information, a system for transmitting monitoring information as well as a method for transmitting monitoring information.

### BACKGROUND

In the state of the art, systems are known that use a virtual private network connection (VPN connection) in order to provide access to a functional unit at a remote location, for instance a broadcasting and/or streaming unit, by using a mobile device such as a mobile phone. The VPN connection is typically used as it ensures high security while providing a secure infrastructure.

However, the implementation of a VPN connection is expensive and a lot of efforts are required in order to ensure that a user using a VPN connection has only access to certain information, for instance monitoring information, of the corresponding unit. Thus, a VPN connection is a complex system with regard to its implementation and configuration.

### SUMMARY

Accordingly, there is a need for an easy and secure access possibility to retrieve monitoring information from a remote location.

Embodiments of the present disclosure provide a transmission device for transmitting monitoring information, in particular monitoring information related to broadcasting and/or streaming. The transmission device is configured to gather monitoring information of a broadcasting and/or streaming unit that is configured to generate a transport stream for broadcasting and/or streaming. The transmission device is further configured to transmit the monitoring information gathered to a cloud unit via a secure connection.

Accordingly, the monitoring information can be provided to a user in an easy manner while forwarding only the monitoring information gathered from the broadcasting and/or streaming unit to the cloud unit being accessible by an end device, for instance a mobile device such as a mobile phone, a tablet, a notebook or any other suitable electronic end device. The secure connection between the transmission device and the cloud unit ensures that the monitoring information is forwarded in a secure manner. Accordingly, it is not required that the user has direct access to the broadcasting and/or streaming unit, also called functional unit, in order to retrieve the monitoring information which simplifies the establishment of the whole system appropriately. A complex virtual private network connection (VPN connection) is no more required for providing the relevant monitoring information to the user being at a remote location with regard to the broadcasting and/or streaming unit. The transmission device itself may comprise the broadcasting and/or streaming unit. The broadcasting and/or streaming unit is configured to generate a transport stream for broadcasting and/or streaming.

A transport stream, for instance a MPEG transport stream, may comprise audio, video and/or program and system information protocol (PSIP) data, namely audio data, video data and/or PSIP data. Usually, the transport stream is used in broadcast systems such as DVB, ATSC and IPTV.

Hence, the transport stream may relate to a container format for the transmission and storage of audio, video, video text and additional data from digital TV. In fact, the transport stream may be established by the packetized elementary stream (PES), namely by encapsulation.

The packetized elementary stream is produced by packaging the elementary stream (ES), which is formed by multiplexing the compressed video and audio signals. Additional information such as program association table (PAT), the program map table (PMT) and other additional information is added to the packaged data stream. For transmission, the transport stream is multiplexed and radiated appropriately. As already discussed, this technology is used, for example, in digital video broadcasting (DVB).

The transport stream may inter alia ensure error checking, namely error correction and synchronization of the data stream, since errors may occur during the transmission via the various transmission media and components.

According to an aspect, the secure connection is a unidirectional one. The direct access to the functional unit, namely the broadcasting and/or streaming unit, via the secure connection is prohibited due to the unidirectional secure connection used for transmitting the monitoring information from the broadcasting and/or streaming unit to the cloud unit. Hence, a direct connection to the broadcasting and/or streaming unit from the outside cannot be established via the unidirectional connection with regard to the data transfer. Therefore, a controlling function is not provided. The user having access to the cloud unit is not enabled to control the broadcasting and/or streaming unit via the cloud unit as the user can only retrieve the monitoring information being provided. Accordingly, it is not necessary to establish a complex virtual private network having certain access rights ensuring that the user can only access the monitoring information without any controlling function.

For establishing the unidirectional connection with regard to the data transfer, a bidirectional protocol can be used, for instance an Internet Protocol (IP) or a Transmission Control Protocol (TCP).

According to another aspect, the monitoring information is provided in real-time. The cloud unit continuously has access to the monitoring information provided by the broadcasting and/or streaming unit which ensures that the monitoring information on the cloud unit is always up-to-date.

In addition, the transmission device may be configured to transmit legacy messages via the secure connection to the cloud unit. For instance, messages according to the Simple Network Management Protocol (SNMP) are used that are transmitted via the secure connection. Accordingly, the monitoring information can be sent in an easy manner as SNMP messages are used wherein the requested security is ensured while using the secure connection.

Further, embodiments of the present disclosure provide a system for transmitting monitoring information, for example monitoring information related to broadcasting and/or streaming, wherein the system comprises at least one broadcasting and/or streaming unit, a cloud unit and at least one transmission device being established by a transmission device as described above. As already mentioned, the transmission device is configured to gather the monitoring information of the functional unit, namely the broadcasting and/or streaming unit, wherein only the monitoring information gathered from the broadcasting and/or streaming unit is forwarded to the cloud unit. Hence, it is ensured that the user has only access to the monitoring information forwarded to the cloud unit while using an end device at a remote location with respect to the location of the broadcasting and/or streaming unit.

As mentioned above, the broadcasting and/or streaming unit is configured to generate a transport stream for broadcasting and/or streaming.

The cloud unit can be considered as an information sink that provides the monitoring information received from the at least one transmission device as a unidirectional connection is established.

According to an aspect, the cloud unit is configured to provide access for a user, for example for a user having a web-enabled end device, such that the user is enabled to access the monitoring information on the cloud unit at least partly. The cloud unit is configured to provide web access for the user such that the user may use an electronic end device having web access for establishing the connection to the cloud unit, for example for getting access to the monitoring information provided on the cloud unit. The connection can be established by a simple web connection, for instance via the hypertext transfer protocol (http).

According to another aspect, the cloud unit is configured to grant access to the monitoring information based on a user login, for example wherein the monitoring information provided by the cloud unit differs with respect to user rights defined by the user login. Thus, the kind of monitoring information provided depends on the user, for example the user rights related to the user login used for getting access to the cloud unit. This ensures that certain users only have access intended by an administrator of the whole system.

According to a certain embodiment, the system comprises a web-enabled end device that is configured to access the monitoring information provided by the cloud unit at least partly, in particular wherein the cloud unit is configured to analyse the monitoring information provided such that the analysing results are provided to the web-enabled end device. The monitoring information provided by the cloud unit can be accessed via each end device being web-enabled provided. As the cloud unit itself is used for analyzing the monitoring information provided by the transmission device, more advanced analysis methods can be applied due to the increased computational power of the cloud unit compared to a single device or unit, for instance the broadcasting and/or streaming unit. The cloud unit may be established by several devices in order to form a cloud computing architecture used for processing big data.

Generally, the end device only has access to the cloud unit, but not directly to the broadcasting and/or streaming unit providing the monitoring information. This ensures that the end device being potentially unsecure does not have direct access to the broadcasting and/or streaming unit processing security relevant data, in particular the broadcasting and/or streaming unit. The access for the end device can be ensured by using standard network applications. Thus, complex virtual private network (VPN) connections are not necessary for providing access to the monitoring information of the broadcasting and/or streaming unit. As the end device only has access to the cloud unit and, further, the secure connection is a unidirectional one, it is ensured that the end device is not enabled to control the corresponding functional unit, for example the broadcasting and/or streaming unit.

Furthermore, the system may comprise several transmission devices, for example at different locations, wherein each of the transmission devices is configured to provide monitoring information to the cloud unit via a secure connection. Thus, the cloud unit may collect the monitoring information of different functional units, namely broadcasting and/or streaming units, being located at different locations wherein the collected monitoring information of the several locations can be accessed by the user via the cloud unit.

For instance, the cloud unit is configured to combine the different monitoring information such that the different monitoring information is accessible, for example wherein the cloud unit is configured to analyze the different monitoring information provided. More data is gathered that can be analyzed appropriately by the cloud unit having higher computational capacities compared to a single device, for instance a broadcasting and/or streaming unit providing the monitoring information. The cloud unit applies advanced analysis methods and concepts while analyzing the corresponding monitoring information such that deeper and more sophisticated analyses of the services are possible as multiple services are analyzed simultaneously, particular multiple services of different locations.

As mentioned above, the system comprises at least one broadcasting and/or streaming unit. The broadcasting and/or streaming unit provides the monitoring information that is forwarded by the transmission device to the cloud unit. Accordingly, the monitoring information being accessible via the cloud unit relates to broadcasting and/or streaming data processed by the broadcasting and/or streaming unit.

According to a certain embodiment, a transmission device and the broadcasting and/or streaming unit are formed as a single device such that the transmission device comprises the broadcasting and/or streaming unit.

Furthermore, several broadcasting and/or streaming units are located in a common intranet area wherein these several units are configured to provide different monitoring information via a common outgoing port. The common intranet area represents a certain location having one transmission device. This transmission device may use a single outgoing port for providing the several monitoring information gathered from the different broadcasting and/or streaming units to the cloud unit. Hence, the information technology security (IT security) is increased as it is easier to secure a single outgoing with respect to several ports used by each broadcasting and/or streaming unit individually.

The system may comprise several locations each defined by an intranet area having several functional units, for example several broadcasting and/or streaming units, wherein each of the intranet areas use a single common outgoing port for providing the monitoring information of the several functional units to the cloud unit.

Further, embodiments of the present disclosure provide a method for providing monitoring information to a user at a remote location, with the following steps: providing monitoring information of at least one broadcasting and/or streaming unit to a transmission device, wherein the broadcasting and/or streaming unit is configured to generate a transport stream for broadcasting and/or streaming, and transmitting the monitoring information gathered via the transmission device to a cloud unit via a secure connection.

The monitoring information gathered from the at least one functional unit, namely the broadcasting and/or streaming unit, is forwarded to the transmission device and/or the cloud unit in a secure manner ensuring that an inadvertent access is prohibited appropriately. For instance, messages according to the Simple Network Management Protocol (SNMP) are used for transmission purposes wherein these messages are transmitted via the secure connection.

According to an aspect, a user accesses the cloud unit via a web interface in order to retrieve the monitoring information provided at least partly. This ensures that the user has access from anywhere, for example from outside of the intranet area that comprises the broadcasting and/or streaming unit.

According to another aspect, the monitoring information is transmitted in real time such that the monitoring information provided by the cloud unit is up-to-date. The user is enabled to access the actual monitoring information in an easy manner while accessing the cloud unit, in particular via the web interface established by the cloud unit.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a system for transmitting monitoring information according to an embodiment of the present disclosure, and

FIG. 2 is a flow chart of a method for providing monitoring information to a user according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The system 10 comprises two different locations 12, 14 each being defined by a local intranet area. The different location 12, 14 each comprise a transmitter, such as a transmission device 16, 18, for transmitting monitoring information. The system 10 further comprises a central cloud unit 20 that has established a first secure connection 22 to the first transmission device 16 of the first location 12 and a second secure connection 24 to the second transmission device 18 of the second location 14. Both secure connections 22, 24 each are unidirectional ones with regard to the data transfer which means that data can only be transmitted in one direction, in particular from the transmission devices 16, 18 to the cloud unit 20.

In some embodiments, however, a protocol can be used ensuring a bidirectional connection such as an Internet Protocol (IP) or a Transmission Control Protocol (TCP) in order to enable the exchange of acknowledgement signals, for example sending acknowledgement signals from the central cloud unit 20 to the transmission device 16, 18.

Nevertheless, the data transfer in some embodiments is a unidirectional one as the transmission device 16, 18 can send data (packages) to the central cloud unit 20 whereas the central cloud unit 20 cannot send data (packages) to the transmission device 16, 18. Accordingly, the central cloud unit 16, 18 has no direct access to the data on the transmission devices 16, 18.

In the shown embodiment, the system 10 also comprises an end device 26 being a mobile device such as a mobile phone, a tablet or a notebook. The end device 26 has access to the cloud unit 20 via the web such that a bidirectional connection 27 between the end device 26 and the cloud unit 20 is established. Accordingly, the end device 26 is web-enabled wherein the cloud unit 20 provides an appropriate web interface.

As shown for the first location 12, the first transmission device 16 communicates with different functional units 28 such that monitoring information is gathered by the transmission device 16. This monitoring information gathered is forwarded to the cloud unit 20 such that this information is provided to the user having access to the cloud unit 20 by its end device 26.

In the shown embodiment, the functional units 28 are established by broadcasting and/or streaming units, for instance a serial digital interface (SDI), an encoder (ENC) and other devices and/or units. In general, the broadcasting and/or streaming units are configured to generate a transport stream that is transmitted to a local receiving unit 36 that is allocated to the dedicated first location 12, for instance Munich, Germany. The local receiving unit 36 may be a television or any other device configured to display the broadcasting and/or streaming data related to the transport stream generated by the broadcasting and/or streaming units.

In a similar manner, the second location 14 comprises several functional units 28 being broadcasting and/or streaming units that are used for generating a transport stream comprising broadcasting and/or streaming data. The transport stream generated is transmitted to a local receiving unit 36 being allocated to the second location 14, for instance Hamburg, Germany.

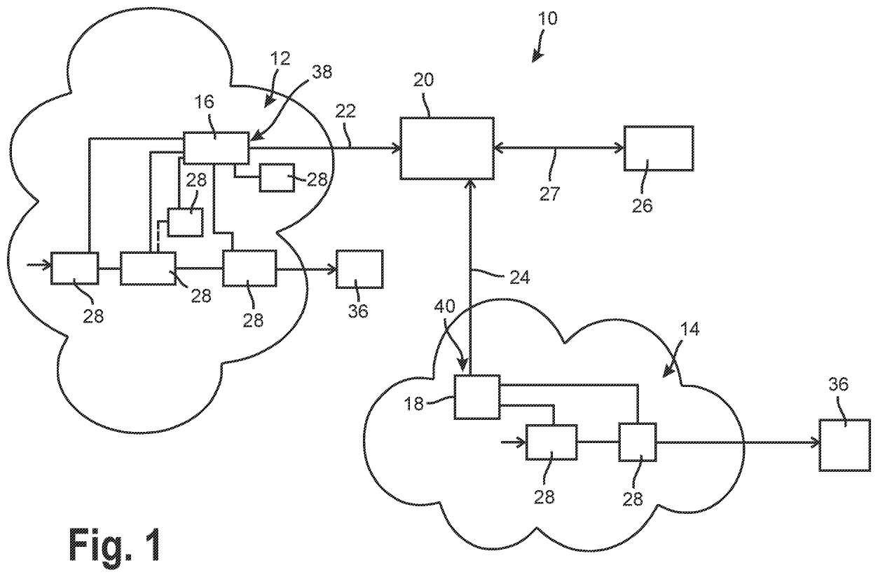

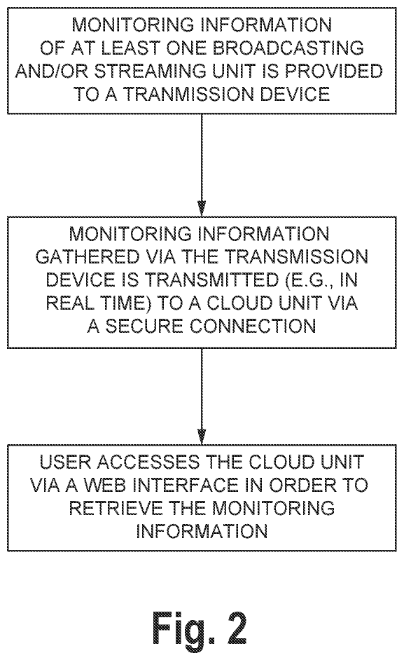

Generally, the transmission devices 16, 18 each gather monitoring information from the several functional units 28 being allocated to the corresponding location 12, 14, particularly the broadcasting and/or streaming units. The transmission devices 16, 18 forward the monitoring information gathered from the different functional units 18 to the cloud unit 20 via the corresponding secure connection 22, 24 for instance a secure hypertext transfer protocol connection (https connection), as shown in FIG. 1 and FIG. 2.

The transmission devices 16, 18 are configured to transmit legacy messages via the dedicated secure connection 22, 24 to the cloud unit 20 such that the monitoring information can be transmitted in an easy manner, for instance.

Even though the transport devices 16, 18 each gather the monitoring information of several functional units 28, for example broadcasting and/or streaming units, the monitoring information is forwarded to the cloud unit 20 via a single outgoing port 38, 40 for each location 12, 14. Thus, the outgoing ports 38, 40 are common outgoing ports for all function units 28 of each location 12, 14. The security for transmitting the monitoring information to the cloud unit 20 is easier to establish as only a single outgoing port 38, 40 has to be secured appropriately. In addition, it is easier to install a firewall protecting only the single outgoing port 38, 40 instead of several outgoing ports for each functional unit 28.

The end device 26 has only access to the cloud unit 20 as it has no access to the functional units 28 themselves via the cloud unit 20, for instance. Thus, the end device 26 may use a standard network application for accessing the cloud unit 20 since the cloud unit 20 only provides the monitoring information forwarded by the transport device(s) 16, 18. The user has no access to the functional units 28, for example the broadcasting and/or streaming units, in order to control the functional units 28. This is inter alia ensured by establishing a unidirectional connection 22, 24 between each transmission device 16, 18 and the central cloud unit 20.

In addition, the cloud unit 20 provides a web interface for user login. Thus, the user accessing the cloud unit 20 via the end device 26 needs a user login. Depending on the user login, in particular the user rights related to the specific user login, only certain portions of the monitoring information gathered can be accessed by the user. Thus, all the information gathered can be provided partly depending on the user rights, role profile or login credential.

Furthermore, the cloud unit 20 may be established by several different devices, in particular computational units, providing together an increased computational power such that deeper and more complex analyses can be applied for analyzing the different monitoring information forwarded to the cloud unit 20 by the several transport devices 16, 18, for example the transport devices 16, 18 located at different locations 12, 14.

As the transport devices 16, 18 forward the monitoring information of several separately formed functional units 28, particularly broadcasting and/or streaming units, deeper and more complex analyses can be performed for gathering more information about the services provided, for instance broadcasting and/or streaming services.

In some embodiments, the transmission devices 16, 18 may comprise a functional unit 28, for example a broadcasting and/or streaming unit.

Accordingly, a system 10 is provided that ensures that the user has easy and secure access to the monitoring information of different locations 12, 14 while it is simultaneously ensured that the user is not enabled to control the functional units 28 which monitoring information is accessible by the user. Hence, unwanted access to the functional units 28 is prevented effectively and easily. The security of the whole system 10 is increased appropriately.

It will be appreciated that several components, including but not limited to the functional units 28, broadcasting and/or streaming units, cloud unit 20, end device 26, etc., have been described herein as “processing” signals or that various signals are being “analyzed” or “compared” by such components. This analysis, processing, comparing or any other functionality described herein, can be carried out in some embodiments of the present disclosure by analog circuitry, digital circuitry, or a combination of analog and digital circuitry, and can include discrete digital or analog circuit elements or electronics, or combinations thereof. Such circuitry is configured and arranged in order to implement the technologies and methodologies set forth herein.

These components may include, in some embodiments, logic for implementing the technologies and methodologies described herein. This logic can be carried out in either hardware or software, or a combination of hardware and software. In some embodiments, one or more of these components includes one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof. In some embodiments, one or more of these components includes a microprocessor and a memory storing logic modules and/or instructions. In an embodiment, one or more of these components includes one or more ASICs having a plurality of predefined logic components. In an embodiment, one or more of these components includes one or more FPGA having a plurality of programmable logic components. In an embodiment, one or more of these components includes hardware circuit implementations (e.g., implementations in analog circuitry, implementations in digital circuitry, and the like, and combinations thereof). In an embodiment, one or more of these components includes combinations of circuits and computer program products having software or firmware instructions stored on one or more computer readable memories that work together to cause a device to perform one or more methodologies or technologies described herein.

Of course, in some embodiments, two or more of these components, or parts thereof, can be integrated or share hardware and/or software, circuitry, etc. In some embodiments, these components, or parts thereof, may be grouped in a single location or distributed over a wide area. In circumstances were the components are distributed, the components are accessible to each other via communication links.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

1-20. (canceled)

21. A system for transmitting monitoring information of broadcasting and/or streaming circuits in local networks, comprising:
a cloud circuit; and
a plurality of local networks, each of the local networks comprising a transmission device and at least one broadcasting and/or streaming circuit configured to generate a transport stream for broadcasting and/or streaming to a respective local receiving unit,
wherein each transmission device of the respective local networks is configured to gather monitoring information of the at least one broadcasting and/or streaming circuit in the respective local networks, each transmission device of the respective local networks being further configured to transmit the monitoring information gathered to the cloud circuit via a unidirectional secure connection such that each of the respective local networks has a dedicated unidirectional secure connection to the cloud circuit, resulting in several unidirectional secure connections,
wherein each of the respective unidirectional secure connections is configured to prohibit a user having access to the cloud circuit from accessing the at least one broadcasting and/or streaming circuit of the respective local networks via the cloud circuit, and
wherein the cloud circuit is configured to combine monitoring information gathered for each of the respective local networks, and wherein the cloud circuit is configured to analyze the combined monitoring information.

22. The system of claim 21, wherein the cloud circuit is configured to grant access to the monitoring information of the respective local networks based on a user login.

23. The system of claim 22, wherein the monitoring information of the respective local networks provided by the cloud circuit differs with respect to user rights defined by the user login.

24. The system of claim 21, wherein the monitoring information of the respective local networks is provided in real time.

25. The system of claim 21, wherein each transmission device of the respective local networks is configured to transmit legacy messages via the respective secure connection of the respective local networks to the cloud circuit.

26. The system of claim 21, wherein the respective local receiving unit is configured to display broadcasting and/or streaming data related to the transport stream generated by the at least one broadcasting and/or streaming circuit of the respective local network.

27. The system of claim 21, wherein at least one of the local networks includes two or more broadcasting and/or streaming circuits.

28. The system according to claim 27, wherein the transmission device of the at least one local network including the two or more broadcasting and/or streaming circuits has a single common outgoing port and is configured to gather and provide the monitoring information of the two or more broadcasting and/or streaming circuits to the cloud circuit via the single common outgoing port.

29. A method for providing monitoring information of broadcasting and/or streaming circuits in local networks to a user at a remote location, comprising:
providing a cloud circuit and a plurality of local networks, each of the local networks comprising a transmission device and at least one broadcasting and/or streaming circuit configured to generate a transport stream for broadcasting and/or streaming to a respective local receiving unit;
providing monitoring information of the at least one broadcasting and/or streaming circuit to the transmission device in the respective local networks;
transmitting, by each transmission device in the respective local networks, the respective monitoring information;
combining the respective monitoring information provided by the transmission devices of the respective local networks in the cloud circuit; and
analyzing the combined monitoring information,
wherein each of the respective local networks has a dedicated unidirectional secure connection to the cloud circuit, resulting in several unidirectional secure connections, wherein each of the respective unidirectional secure connections is configured to prohibit a user having access to the cloud circuit from accessing the at least one broadcasting and/or streaming circuit of the respective local networks via the cloud circuit.

30. The method according to claim 29, wherein a user accesses the cloud circuit via a web interface in order to retrieve the monitoring information of the respective local networks.

31. The method according to claim 29, wherein the monitoring information of the respective local networks is transmitted in real time.

32. The method according to claim 29, wherein the respective local receiving unit is configured to display broadcasting and/or streaming data related to the transport stream generated by the at least one broadcasting and/or streaming circuit of the respective local network.

33. The method according to claim 29, wherein the monitoring information of the respective local networks provided by the cloud circuit differs with respect to user rights defined by a user login.

34. The method according to claim 29, further comprising the transmission device of the respective local networks transmitting legacy messages via the respective secure connection of the respective local networks to the cloud circuit.

35. The method according to claim 29, wherein at least one of the local networks includes two or more broadcasting and/or streaming circuits.

36. The method according to claim 35, wherein the transmission device of the at least one local network including the two or more broadcasting and/or streaming circuits has a single common outgoing port, the method further comprising providing the monitoring information of the two or more broadcasting and/or streaming circuits to the cloud circuit via the single common outgoing port.

37. A non-transitory computer-readable medium including instructions configured to cause a computer system to perform steps for providing monitoring information of broadcasting and/or streaming circuits in local networks to a user at a remote location,
wherein the computer system comprises a cloud circuit and a plurality of local networks, each of the local networks comprising a transmission device and at least one broadcasting and/or streaming circuit configured to generate a transport stream for broadcasting and/or streaming to a respective local receiving unit,
the steps comprising:
providing monitoring information of the at least one broadcasting and/or streaming circuit to the transmission device in the respective local networks;
transmitting, by each transmission device in the respective local networks, the respective monitoring information;
combining the respective monitoring information provided by the transmission devices of the respective local networks in the cloud circuit; and
analyzing the combined monitoring information,
wherein each of the respective local networks has a dedicated unidirectional secure connection to the cloud circuit, resulting in several unidirectional secure connections, wherein each of the respective unidirectional secure connections is configured to prohibit a user having access to the cloud circuit from accessing the at least one broadcasting and/or streaming circuit of the respective local networks via the cloud circuit.

38. The non-transitory computer-readable medium of claim 37, wherein the cloud circuit is accessible via a web interface in order to retrieve the monitoring information of the respective local networks.

39. The non-transitory computer-readable medium of claim 37, wherein the monitoring information of the respective local networks is transmitted in real time.

40. The non-transitory computer-readable medium of claim 37, wherein at least one of the local networks includes two or more broadcasting and/or streaming circuits, and wherein the transmission device of the at least one local network including the two or more broadcasting and/or streaming circuits has a single common outgoing port, the steps further comprising providing the monitoring information of the two or more broadcasting and/or streaming circuits to the cloud circuit via the single common outgoing port.
